(19) United States
(12) Patent Application Publication
(10) Pub. No.: US 2008/0275705 A1
(43) Pub. Date: Nov. 6, 2008

(54) Battery Tester with Wireless Voice Status Messages

(75) Inventors: Edward W. Deveau, Pompano Beach, FL (US); Conrad C. Cover, Coconut Creek, FL (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 11/744,847

(22) Filed: May 5, 2007

(51) Int. Cl. G10L 13/00; G08B 3/00; H04B 1/034

(52) U.S. Cl. 704/258; 340/660; 455/95

(57) ABSTRACT

Methods and systems are disclosed for providing wireless data transfer and voice messages in a voltage measurement device. In some embodiments, the methods and systems dynamically construct voice messages that substantially correspond to text messages displayed on a display of the measurement device. The voice messages may be assembled from words and phrases that have been prerecorded and stored in a voice module of the measurement device. A wireless communication module transmits the voice messages from the voice module to a wireless receiver that may be worn or carried by the operator. The wireless communication module also facilitates wireless transfer of data from the measurement device to a computer. Such an arrangement allows an operator to conduct tests in noisy, cramp, and/or hazardous environments without having to divert his/her eyes to see or strain his/her ears to hear the measurement device.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO APPENDIX

Not applicable

### BACKGROUND OF THE INVENTION

1. Field of the Invention

The invention disclosed and taught herein relates generally to voltage measurement devices. More specifically, the invention relates to voltage measurement devices that are capable of providing wireless voice messages and data transfer.

2. Description of the Related Art

Power conditioning and distribution has become an increasingly important function in today's high-density data centers and IT (information technology) environments. Uninterruptible power supplies (UPS) are by far the most reliable way of providing such power conditioning and distribution. It is important, therefore, that the USP are frequently and properly tested in order to keep them in correct working condition.

Testing a UPS typically involves using a hand-held voltage measurement device, such as a voltmeter, to check the voltage (and current and resistance) of the UPS battery. An example of a popular voltage measurement device for testing a UPS is the Cellcorder line of battery multimeters available from Albercorp of Pompano Beach, Fla., USA. In a typical procedure, an operator applies the probes of the measurement device across one or more battery cells of the UPS, and the measurement device displays the voltage across the cells.

Because a typical UPS can put out extremely high voltages (e.g., 540 volts DC), the operator must be careful not to take his/her eyes off the probes while they are in contact with the cells. As such, it can be difficult to view the measurements on the measurement device when a test is in progress. The problem is compounded by the cramped cabinets in which most UPS batteries are confined, which leave little room for the operator to maneuver the probes or reposition his/her body.

To address the above problem, some measurement devices provide synthesized voice readout of the numerical measurements. However, because the AC-DC conversion and subsequent DC-AC conversion in the UPS is a generally loud process, it can be difficult to hear any sounds generated by the measurement device during a test. Moreover, a measurement device like a Cellcorder battery multimeter provides numerous advance functions besides mere measurements, such as data transfer, status assessments, instructions for performing tests, warning messages, and the like. Simple voice readout of the numerical measurements is inadequate for these additional functions.

Accordingly, what is needed is a measurement device that allows an operator to conduct tests in noisy, tight, and/or hazardous environments without having to divert his/her eyes to see or strain his/her ears to hear the measurement device. More particularly, what is needed is a measurement device with the above advantages that can also accommodate multiple advance functions, such as data transfer, status assessments, tests instructions, warning messages, and the like.

### BRIEF SUMMARY OF THE INVENTION

The present invention is directed to methods and systems for providing wireless voice messages and data transfer in a voltage measurement device. In some embodiments, the methods and systems dynamically construct voice messages that substantially correspond to text messages displayed on a display of the measurement device. The voice messages may be assembled from words and phrases that have been prerecorded and stored in a voice module of the measurement device. A wireless communication module transmits the voice messages from the voice module to a wireless receiver that may be worn or carried by the operator. The wireless communication module also facilitates wireless transfer of data from the measurement device to a computer. Such an arrangement allows an operator to conduct tests in noisy, cramp, and/or hazardous environments without having to divert his/her eyes to see or strain his/her ears to hear the measurement device.

In general, in one aspect, the invention is directed to a method of constructing a voice message in a voltage measurement device. The method comprises conducting a test using the voltage measurement device and storing a first message identifier in a message table based on the test, the first message identifier identifying a first voice message. The message further comprises storing a second message identifier in the message table based on the test, the second message identifier identifying a second voice message, and combining the first voice message and the second voice message into a unitary voice message using the message table.

In general, in another aspect, the invention is directed to a voltage measurement device for conducting a test in noisy, cramped, and hazardous environments. The voltage measurement device comprises a measurement module configured to acquire measurement data and to generate a message based on the measurement data and a voice module connected to the measurement module, the voice module configured to receive the message from the measurement module and generate a voice message from the message. The voice measurement device further comprises a wireless communication module connected to the voice module, the wireless communication module configured to receive the voice message and transmit the voice message as a wireless transmission.

In general, in still another aspect, the invention is directed to a computer-readable medium in a voltage measurement device. The computer-readable medium is encoded with computer-readable instructions for causing the voltage measurement device to acquire measurement data and store a first message identifier in a message table based on the measurement data, the first message identifier identifying a first voice message. The computer-readable medium is further encoded with computer-readable instructions for causing the voltage measurement device to a store a second message identifier in the message table based on the measurement data, the second message identifier identifying a second voice message and combine the first voice message and the second voice message into a single voice message using the message table.

### BRIEF DESCRIPTION OF THE SEVERAL VIEWS OF THE DRAWINGS

FIG. 1 illustrates an exemplary measurement device having dynamic wireless voice messages and data transfer according to embodiments of the invention;

FIG. 2 illustrates an exemplary block diagram of the measurement device of FIG. 1 according to embodiments of the invention;

FIG. 3 illustrates an exemplary flow chart for a method of constructing and transmitting a voice message according to embodiments of the invention;

FIG. 4 illustrates an exemplary flow chart for a method of constructing a test-failed voice message in a measurement device according to embodiments of the invention;

FIG. 5 illustrates an exemplary flow chart for a method of constructing a test-passed voice message in a measurement device according to embodiments of the invention;

FIG. 6 illustrates an exemplary flow chart for a method of constructing and transmitting an operator message in a measurement device according to embodiments of the invention; and

FIG. 7 illustrates a more detailed flow chart for a method of constructing the operator message of FIG. 6 according to embodiments of the invention.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention are described below with reference to block diagrams and/or operational illustrations of methods. It will be understood that each block of the block diagrams and/or operational illustrations, and combinations of blocks in the block diagrams and/or operational illustrations, may be implemented by analog and/or digital hardware, and/or computer program instructions. Computer programs instructions for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the Figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Applicants have created methods and systems for providing wireless voice messages and data in a voltage measurement device. The method and system construct, on an as needed basis, voice messages to be used with the measurement device. The term “message” as used herein may refer to a single word, a phrase, or an entire sentence. These voice messages preferably, but not necessarily, correspond to text messages that are displayed on the measurement device during normal operation thereof. In some embodiments, the voice messages may be assembled, preferably in real time, from words and phrases that have been spoken by a person (i.e., not synthesized). The prerecorded words and/or phrases may be stored on a voice module of the measurement device. The voice messages may then be transmitted to a wireless receiver worn or carried by the operator. The wireless communication module also facilitates wireless transfer of data from the measurement device to a computing device. Such an arrangement allows an operator to conduct tests in noisy, tight, and/or hazardous environments without having to divert his/her eyes to see or strain his/her ears to hear the measurement device.

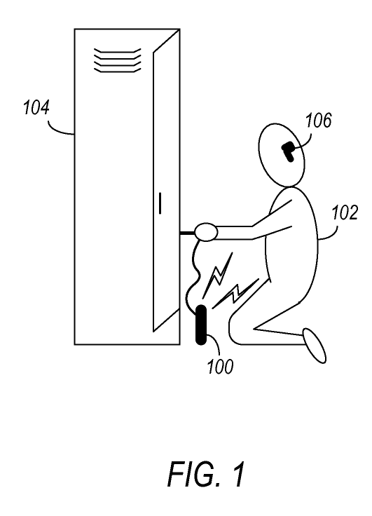

FIG. 1 illustrates of an exemplary voltage measurement device 100 for providing wireless voice messages and data transfer according to embodiments of the invention. The voltage measurement device 100 shown here may be used in any application known to those having ordinary skill in the art where measurements of voltage, current, resistance, and other parameters are needed. Because of its wireless voice message and data transfer capabilities, however, the measurement device 100 is particularly useful in noisy, tight, and/or hazardous environments, like a UPS cabinet or a battery backup room. Such an environment is shown in FIG. 1, where an operator 102 can be seen using the measurement device 100 to test a UPS housed in a cabinet 104. As explained earlier, it can difficult for the operator 102 to see and hear a measurement device in such an environment.

In accordance with embodiments of the invention, the measurement device 100 is configured to wirelessly transmit measurement data as well as cell status information (e.g., “unit overheating”), test instructions (e.g., “reverse polarity”), warnings (e.g., “low test current”), and other information as voice messages. In this regard, the measurement device 100 is similar to the CRT-400 Cellcorder Battery Multimeter available from Albercorp of Pompano Beach, Fla., USA. The voice messages may then be received by the operator 102 via a wireless receiver 106. The wireless receiver 106 may be any type of wireless receiver known to those having ordinary skill in the art, including an infrared (IR) receiver, radio frequency (RF) receiver, and the like. Such a wireless receiver 106 may also take any form factor known to those having ordinary skill in the art, including a handheld receiver (with accompanying earphones), a headset receiver, an in-ear receiver, and the like. Similarly, the transmission from the measurement device 100 may be sent using any suitable wireless protocol known to those having ordinary skill in the art, including WiFi, Bluetooth, IEEE 802.11-b/g, and the like. In a preferred embodiment, the transmissions from the measurement device 100 may be Bluetooth transmissions, and the wireless receiver 106 may be a Bluetooth ear clip receiver that allows the operator 102 to hear the voice messages directly in his/her ear.

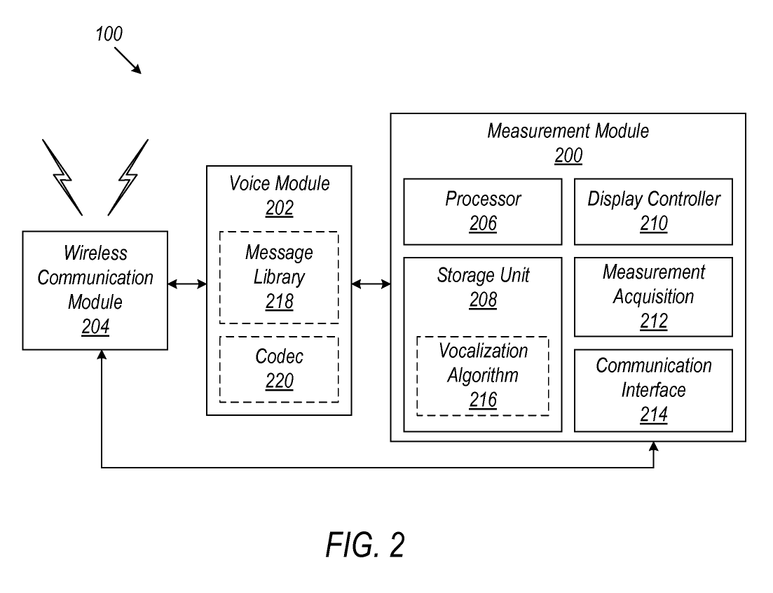

FIG. 2 illustrates the measurement device 100 in more detail. In some embodiments, the measurement device 100 has a number of functional modules, including a measurement module 200, a voice module 202, and a wireless communication module 204. Briefly, the measurement module 200 is responsible for acquiring the measurements, including voltages, currents, resistances, and other parameters that are needed for a proper test (e.g., a UPS battery). From the test, the measurement module 200 generates a series of address locations or identifiers that are stored in a voice message table, each location corresponding to a certain prerecorded word or phrase, that are subsequently converted into an actual voice message by the voice module 202. The voice message is then transmitted via wireless transmission by the wireless communication module 204 to the receiver 106. Each of these modules 200, 202, and 204 are described in more detail below.

Referring still to FIG. 2, the measurement module 200 may comprise a number of functional components, including a processor 206, a data storage unit 208, a display controller 210, a measurement acquisition unit 212, and a communication interface 214. In general, the processor 206 manages the overall operation of the measurement module 200 as well as the interaction between the various individual functional components. The storage unit 208 provides long-term and temporary storage for any data and/or computer-readable instructions used by the measurement module 200. The display controller 210 is configured to display information generated by the measurement module 200 on a display, typically an LCD (not expressly shown). Such information may include measurement data as well as cell status information, test instructions, warnings, and other test-related information. The measurement acquisition unit 212 is responsible for the actual measurement of voltages, currents, resistances, and other parameters that are needed for a proper test. Finally, the communication interface 214 implements any serial and/or parallel communication protocols needed for the measurement module 200 to communicate with external devices (e.g., a computer).

In accordance with embodiments of the invention, the storage unit 208 may store a vocalization algorithm 216 (or computer-readable instructions therefor) for constructing voice messages that convey the measurement data, cell status information, test instructions, warnings, and other information generated by the measurement module 200. The processor 206 may then execute the vocalization algorithm 216 to dynamically construct the voice messages, for example, by piecing together appropriate words and/or phrases or selecting whole messages that have already been prerecorded in their entirety (i.e., no construction needed). These whole and/or dynamically constructed voice messages preferably, but not necessarily, correspond to the information already being displayed by the display controller 210 as part of the normal operation of the measurement module 200. Note that the words and/or phrases that are pieced together may or may not form a verbatim reproduction of the information displayed on the display of the measurement module 200 so long as the main point of the information is preserved. In either case, the vocalization algorithm 216 may simply tap into the displayed information (typically alphanumeric) and obtain the needed words and phrases. The vocalization algorithm 216 may then look up corresponding address locations (or other identifiers) for the words and phrases in a message table. A non-exhaustive example of a message table showing possible address locations and corresponding messages is illustrated in Table 1 below.

TABLE 1

| Address | Message |
|---|---|
| 0–10 | Zero, one, two, three, four, five, six, seven, eight, nine, ten |
| 11–19 | Eleven, twelve, thirteen, fourteen, fifteen, sixteen, seventeen, |
| | eighteen, nineteen |
| 20 | Twenty |
| 21 | Thirty |
| 22 | Forty |
| 23 | Fifty |
| 24 | Sixty |
| 25 | Seventy |
| 26 | Eighty |
| 27 | Ninety |
| 28 | Hundred |
| 29 | Thousand |
| 30 | Ready to test |
| 31 | Ready to test string |
| 32 | Cell |
| 33 | Module |
| 34 | Test in progress |
| 35 | Test completed |
| 36 | Test |
| 37 | Testing of string |
| 38 | Scan barcode |
| 39 | Volts |
| 40 | Voltage |
| 41 | Resistance |
| 42 | Micro-ohms |
| 43 | Temperature |
| 44 | Point |
| 45 | Intercell |
| 46 | Select done to continue |
| 47 | Leads |
| 48 | To |
| 49 | Is |
| 50 | For |
| 51 | The |
| 52 | Stored value is |
| 53 | Connection |
| 54 | Violated preprogrammed threshold |
| 55 | Warning |
| 56 | Check test lead connections |
| 57 | Reverse polarity |
| 58 | Excessive voltage across intercell |
| 59 | Low test current |
| 60 | Excessive test current |
| 61 | High voltage detected |
| 62 | Wrong voltage mode |
| 63 | Unit overheating |
| 64 | Please wait |
| 65 | Select |
| 66 | Done |
| 67 | Continue |
| 68 | Over-range |
| 69 | Stored |
| 70 | Readings are stored |
| 71 | Connect to next cell |
| 72 | String |
| 73 | Completed |
| 74 | Remove |
| 75 | Immediately |
| 76 | Warning, high voltage detected. Remove test leads immediately |
| 77 | Warning, excessive voltage across intercell test leads. Remove |
| | test leads immediately |
| 78 | Warning, excessive test current. Possible test lead connection |
| | problem |
| 79 | Warning, low test current, faulty cell or possible test lead |
| | connection problem |
| 80 | Warning, low battery detected |
| 81 | Warning, no float readings exist. Are you sure you want to |
| | continue? |
| 82 | Warning, voltage must be within 0 to 2.5 volts before test can |
| | continue |
| 83 | Warning, voltage must be within 2.5 to 7.5 volts before test can |
| | continue |
| 84 | Warning, voltage must be within 7.5 to 15 volts before test can |
| | continue |
| 85 | Warning, voltage must be within 15 to 20 volts before test can |
| | continue |
| 86 | Warning, file exists. Do you want to overwrite? |
| 87 | Warning, existing data will be erased |
| 88 | Warning, are you sure you want to delete site? |
| 89 | Warning, reading exists. Do you want to overwrite? |
| 90 | Warning, no infrared link |
| 91 | Warning, infrared port not ready |
| 92 | Warning, all data in temporary storage will be erased |
| 93 | Warning, internal load temperature has exceeded operating |
| | temperature. Testing is disabled until temperature is normal |
| 94 | Warning, all site configuration data will be restored to default. |
| 95 | Warning, no voltage detected. Check test leads |
| 96 | Scan received |
| 97 | And |

From Table 1, the vocalization module 216 may string together several address locations (or other identifiers) to construct a desired voice message. For example, to construct the message “Warning, check test lead connections,” the vocalization module 216 may look up address locations 55 and 56 from Table 1. These address locations may then be combined in a voice message table that can be used to form the above message. The vocalization module 216 may also look up the address locations for completely predefined voice messages, such as any of the messages located at address locations 76-95. In either case, the processor 206 may thereafter send the voice message table to the voice module 202 for conversion into an actual voice message.

Referring still to FIG. 2, the voice module 202 may be any commercially available voice module (e.g., module no. ISD5116S from Winbond Electronics Corp. of San Jose, Calif., USA) having sufficient storage capacity to store the prerecorded words and phrases listed in Table 1. In some embodiments, the prerecorded words and phrases may be stored in a message library 218 of the voice module 202. These prerecorded words and phrases are preferably stored as digital versions of the words and phrases actually spoken by a person, and the storage locations of the words and phrases preferably correspond to the addresses in listed for the words and phrases in Table 1. Both Table 1 and the message library 218 may be updated and modified from time to time as needed. A codec 220 in the voice module 202 encodes the words and phrases using any suitable encoding scheme known to those having ordinary skill in the art (e.g., Pulse Width Modulation, Pulse Code Modulation, etc.) prior to transmission by the wireless communication module 204.

The wireless communication module 204, like the voice module 202, may be any commercially available wireless communication module (e.g., module no. BR-SC40A from BlueRadios, Inc. of Englewood, Colo., USA) provided it has sufficient bandwidth to transmit both voice and data. As understood by those having ordinary skill in the art, such a wireless communication module 204 typically can transmit as well as receive wireless communication. In accordance with embodiments of the invention, the wireless communication module 204 is configured to receive the encoded words and/or phrases from the voice module 202 and transmit these words and/or phrases using a suitable wireless communication protocol. In a preferred embodiment, the wireless communication protocol is Bluetooth, although WiFi or any other suitable wireless communication protocol may certainly be used.

In operation, generally, upon receiving a voice message table from the measurement module 200, the voice module 202 retrieves digitized versions of the prerecorded words and/or phrases from the message library 218. These prerecorded words and/or phrases are those that correspond to the message locations contained in the voice message table. The voice module 202 thereafter encodes the prerecorded words and/or phrases using the codec 220 and forwards the encoded words and/or phrases to the wireless communication module 204. The wireless communication module 204 subsequently receives the encoded words and/or phrases and transmits them using an appropriate wireless communication protocol in a manner known to those having ordinary skill in the art. In a similar fashion, serial or parallel data received from the measurement module 200 may also be transmitted via the wireless communication module 204 in a manner known to those having ordinary skill in the art.

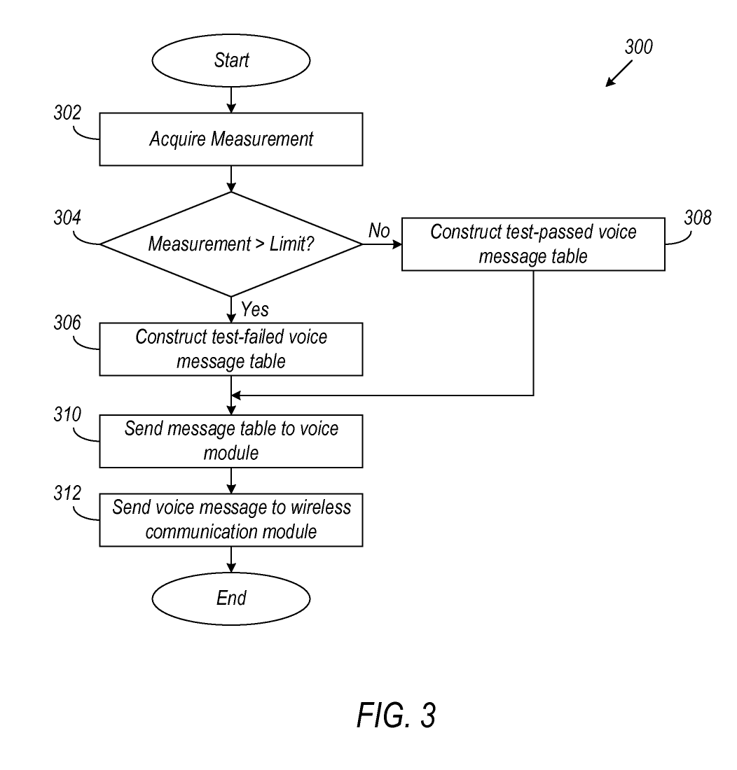

Thus far, the invention has been described with respect to a few specific implementations. Following now in FIGS. 3-7 are general methodologies that may be used to construct voice messages for a measurement device according to embodiments of the invention. These methodologies may be used whether or not the voice messages correspond to information being displayed on the display of the measurement device. It should be noted that although several discrete steps are shown in FIGS. 3-7, those having ordinary skill in the art will understand that one or more of these steps may be combined into a single step, and that any individual step may be divided into several constituent steps, without departing from the scope of the invention. Moreover, although the steps in FIGS. 3-7 are arranged in a particular sequence, those having ordinary skill in the art will recognize that one or more of the steps may be performed outside the sequence shown without departing from the scope of the disclosed embodiments.

Referring first to FIG. 3, an exemplary flow chart for a method 300 of constructing and transmitting voice messages while obtaining a measurement in a measurement device according to embodiments of the invention is shown. As mentioned above, such voice messages may (as described here) or may not correspond to information being displayed on the display of the measurement device. The method 300 begins at step 302, where a desired measurement, such as voltage, current, resistance, and other parameters, is acquired. At step 304, a determination is made as to whether the measurement is above (or below) a certain predefined threshold. If yes, then at step 306 an appropriate test-failed voice message table is constructed based on the information displayed by the measurement device. If no, then at step 308, an appropriate test-passed voice message table is constructed based again on the information displayed by the measurement device. At step 310, the constructed message table is forwarded to a voice module for conversion to a voice message. The voice message is subsequently forwarded to a wireless communication module for transmission at step 312 using an appropriate wireless communication protocol.

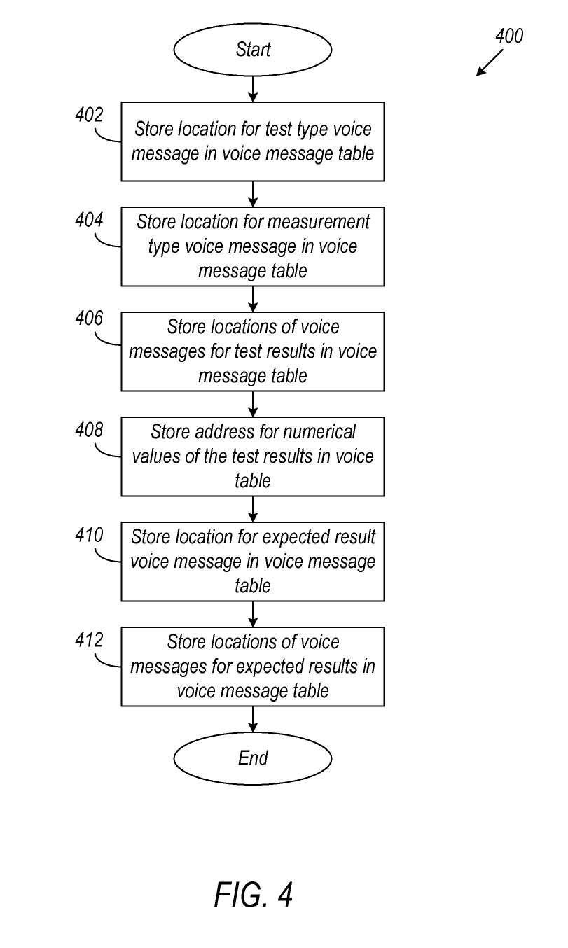

FIG. 4 illustrates an exemplary flow chart for a method 400 of constructing a test-failed voice message table (see FIG. 3, step 306) in a measurement device according to embodiments of the invention. The method 400 begins at step 402, where the address location of a desired test type voice message (e.g., “cell,” “intercell,” “module,” etc.) is stored in a voice message table. At step 404, the address location of a measurement type voice message (e.g., “voltage,” “current,” “resistance,” etc.) is stored in the voice message table. At step 406, the address location of the voice message for the result of the test (e.g., “violated pre-programmed threshold,” etc.). The address locations for voice messages making up the numerical values of the test results are thereafter stored in the voice message table at step 408. Thus, for example, a result of 2.3 volts would cause the address locations for the words “two,” “point,” “three,” and “volts” to be stored in the voice message table. At step 410, the address location for the expected result voice message (e.g., “stored value is,” etc.) is stored in the voice message table. Finally, at step 412, the address locations for the voice messages making up the numerical values of the expected results are stored in the voice message table.

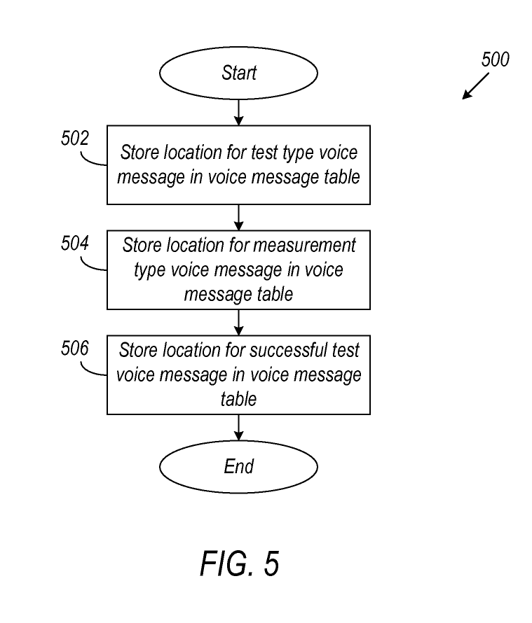

FIG. 5 illustrates an exemplary flow chart for a method 500 of constructing a test-passed voice message table (see FIG. 3, step 308) in a measurement device according to embodiments of the invention. The method 500 begins at step 502, where the address location for a test type voice message (e.g., “cell,” “intercell,” “module,” etc.) is stored in a voice message table. At step 504, the address location for a measurement type voice message (e.g., “voltage,” “current,” “resistance,” etc.) is stored in the voice message table. Finally, at step 506, the address location for a successful test voice message (e.g., “test completed,” etc.) is stored in the voice message table.

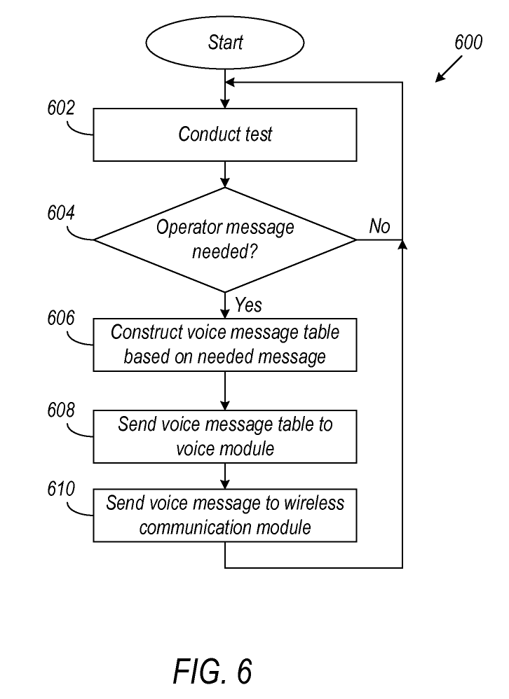

FIG. 6 illustrates an exemplary flow chart for a general method 600 of constructing and transmitting voice messages in a measurement device during a test according to embodiments of the invention. The method begins at step 602, where a test is conducted with the measurement device. At step 604, a determination is made as to whether an operator message (e.g., status information, test instructions, warning messages, etc.) is needed. As before, the operator message may or may not be already displayed on the display of the measurement device. If the answer is no, then the test is continued at step 602. If the answer is yes, then a voice message table is dynamically constructed based on the operator message that is needed at step 606. The constructed voice message table is thereafter sent to a voice module at step 608 where it is converted to an actual voice message using prerecorded words and/or phrases stored in the voice module. At step 610, the voice message is sent to a wireless communication module to be transmitted using an appropriate wireless communication protocol, and the method 600 returns to step 602 to continue with the test.

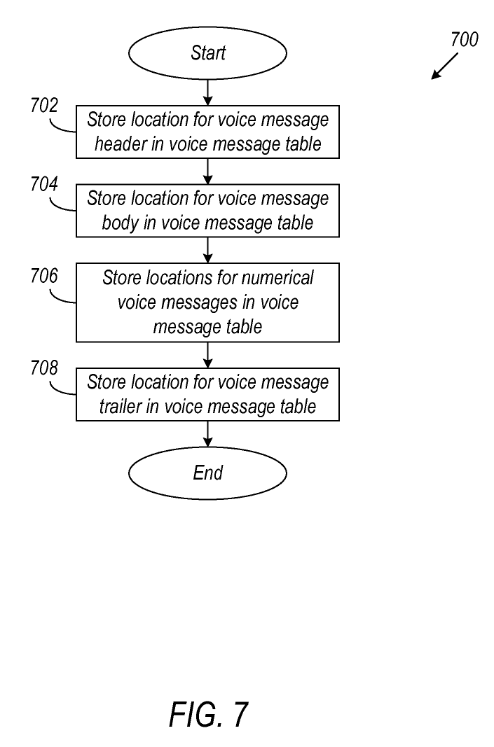

FIG. 7 illustrates an exemplary flow chart for a method 700 of constructing a voice message in a measurement device according to embodiments of the invention. The method 700 begins at step 702, where the address location for a voice message header (if any) is stored in a voice message table. In some embodiments, one or more appropriate entries from Table 1, such as entry numbers 30-43, 45, and the like, may be designated as candidates for the voice message header. At step 704, the address locations for a voice message body (if any) is stored in the voice message table. In some embodiments, one or more appropriate entries from Table 1, such as entry numbers 46-65 and the like, may be designated as candidates for the voice message body. At step 706, the address locations for numerical value voice messages (if any) are stored in the voice message table. In some embodiments, one or more appropriate entries from Table 1, such as entry numbers 0-29 and the like, may be designated as candidates for the numerical value voice messages. Finally, at step 708, the address location for a voice message trailer (if any) is stored in the voice message table. In some embodiments, one or more appropriate entries from Table 1, such as entry numbers 66, 73, and the like, may be designated as candidates for the voice message trailer.

The foregoing description of the invention has been provided in the context of preferred and other embodiments and not every embodiment of the invention has been described. Obvious modifications and alterations to the described embodiments are available to those of ordinary skill in the art. For example, instead of address locations, it is possible for embodiments of the invention to simply associate message numbers (or other identifiers) with the different messages so that any message may be identified by its message number regardless of its actual storage address location. Furthermore, other types of battery test applications besides a UPS battery test may also benefit from embodiments of the invention. Therefore, the disclosed (and undisclosed) embodiments are not intended to limit or restrict the scope or applicability of the invention conceived of by the Applicants; rather, in conformity with the patent laws, Applicants intend to fully protect all such modifications and improvements that come within the scope or range of equivalent of the following claims.

What is claimed is:

1. A method of constructing a voice message in a voltage measurement device, the method comprising:
conducting a test using the voltage measurement device;
storing a first message identifier in a message table based on the test, the first message identifier identifying a first voice message;
storing a second message identifier in the message table based on the test, the second message identifier identifying a second voice message; and
combining the first voice message and the second voice message into a unitary voice message using the message table.

2. The method according to claim 1, wherein the combining of the first and second voice messages occurs and in real time during the conducting of the tests.

3. The method according to claim 1, wherein the first and second voice messages are prerecorded words spoken by a person.

4. The method according to claim 1, wherein the unitary voice message includes one or more of: measurements, status information, test instructions, and warning messages.

5. The method according to claim 1, wherein the unitary voice message substantially corresponds to information displayed on a display of the voltage measurement device.

6. The method according to claim 1, wherein the voltage measurement device is a battery multimeter.

7. A voltage measurement device for conducting a test in noisy, cramped, and hazardous environments, comprising:
a measurement module configured to acquire measurement data and to generate a message based on the measurement data;
a voice module connected to the measurement module, the voice module configured to receive the message from the measurement module and generate a voice message from the message; and
a wireless communication module connected to the voice module, the wireless communication module configured to receive the voice message and transmit the voice message as a wireless transmission.

8. The voltage measurement device according to claim 7, wherein the wireless communication module transmits the voice message using one of the following wireless communication protocols: Bluetooth and WiFi.

9. The voltage measurement device according to claim 7, wherein the wireless communication module is also connected to the measurement module, the wireless communication module being further configured to receive data from the measurement module and transmit the data using one of the following wireless communication protocols: Bluetooth and WiFi.

10. The voltage measurement device according to claim 7, wherein the voice module is further configured to encode the voice message using one of the following encoding schemes: Pulse Width Modulation and Pulse Code Modulation.

11. The voltage measurement device according to claim 7, wherein the voice message is generated from prerecorded words spoken by a person.

12. The voltage measurement device according to claim 7, wherein the voice message includes one or more of: measurements, status information, test instructions, and warning messages.

13. The voltage measurement device according to claim 7, wherein the voice message substantially corresponds to information displayed on a display of the voltage measurement device.

14. The voltage measurement device according to claim 7, wherein the voltage measurement device is a battery multimeter.

15. A computer-readable medium in a voltage measurement device, the computer-readable medium encoded with computer-readable instructions for causing the voltage measurement device to:
acquire measurement data;
store a first message identifier in a message table based on the measurement data, the first message identifier identifying a first voice message;
store a second message identifier in the message table based on the measurement data, the second message identifier identifying a second voice message; and
combine the first voice message and the second voice message into a single voice message using the message table.

16. The computer-readable medium according to claim 15, wherein the computer-readable instructions cause a voltage measurement device to combine the first and second voice messages occurs and in real time during the conducting of the tests.

17. The computer-readable medium according to claim 15, wherein the first and second voice messages are prerecorded words spoken by a person.

18. The computer-readable medium according to claim 15, wherein the single voice message includes one or more of: measurements, status information, test instructions, and warning messages.

19. The computer-readable medium according to claim 15, wherein the single voice message substantially corresponds to information displayed on a display of the voltage measurement device.

20. The computer-readable medium according to claim 15, wherein the voltage measurement device is a battery multimeter.
